(19) United States
(12) Patent Application Publication
(10) Pub. No.: US 2009/0010628 A1
(43) Pub. Date: Jan. 8, 2009

(54) Camera Apparatus and a Method and Software For Using Such

(76) Inventors: Sanna M. Koskinen, Tampere (FI); Heli Jarventie, Tampere (FI); Nina Maki, Tampere (FI); Katja Konkka, Tampere (FI); Paivi Heikkila, Tampere (FI); Sanna Lindroos, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/791,508

(22) PCT Filed: Nov. 15, 2005
(86) PCT No.: PCT/FI05/50410

§ 371 Date: Feb. 21, 2008

(30) Foreign Application Priority Data
Nov. 24, 2004 (FI) 20045457

(51) Int. Cl. G03B 15/00

(52) U.S. Cl. 396/5

(57) ABSTRACT

An improved camera apparatus and diversification of the use of a camera apparatus such that when the trigger for taking a picture is activated, a certain predefined sound clip of the camera apparatus is activated, which sound clip is played with the sound-reproducing equipment of the camera apparatus before taking a picture. The camera apparatus according to the embodiments of the invention comprises a trigger, which can be activated for taking a picture, and a processor and associated software for activating a certain predefined sound clip after trigger activation, and sound-reproducing equipment for playing the sound clip before taking a picture.

### CROSS REFERENCE TO RELATED APPLICATIONS

This application is the National Stage of International Application No. PCT/FI05/050410 filed Nov. 15, 2005 which was published in English on Jun. 1, 2006 under International Publication Number WO 2006/056655 and which in turn in claiming priority from Finnish Patent Application 20045457 filed on Nov. 24, 2004 under §119.

### TECHNICAL FIELD

The invention relates to an improved camera apparatus and diversification of the use of a camera apparatus.

### BACKGROUND OF THE INVENTION

Typically, persons photographed with a camera are set in place and they are asked to stay such that the picture to be taken would be as good as possible. A good picture is a subjective concept, but generally subjects to be photographed should at least stay still in place in order to achieve a clear picture. Attention of the subjects photographed may be attracted for example by flashing the flashlight before taking the picture in order to make the subjects photographed look towards the camera. Traditionally the photographer has asked the subjects photographed to say “cheese” or has made faces to make them smile and relax just before taking the picture. Professional photographers sometimes use auxiliary equipment for attracting the attention of the subjects photographed and/or for making the persons photographed smile at the moment of taking the picture. A professional photographer may have, for example, a figure bouncing out from a box, which is used to make the persons photographed smile at the moment of taking the picture. All measures according to the prior art technique for making the persons photographed relax and/or laugh depend on the photographer, his/her characteristics, skills and action at the moment of taking the picture.

### SUMMARY OF THE INVENTION

One object of the invention is to diversify the features of a camera apparatus. One object of the invention is to reduce the effect of the photographer's action and characteristics on the final picture.

The objects are so achieved that after activating the trigger button of the camera, a certain predefined sound clip is played with the loudspeaker of the apparatus before taking the picture.

The invention is characterized in what is set forth in the claims.

In a method according to one embodiment of the invention for taking a picture with a camera device, when the trigger for taking a picture is activated, a certain predefined sound clip of the camera device is activated, which sound clip is played with the sound-reproducing equipment of the camera device before taking the picture. Thus the persons photographed are automatically performed a desired sound clip just before taking the picture. By using the sound clip it is possible to draw the attention of the subjects photographed, make them laugh, amuse or smile, or to create a relaxed atmosphere. According to some embodiments of the invention, happier faces and more relaxed persons can be achieved in the pictures to be taken irrespective of the photographer's personal characteristics, skills or action at the moment of photographing. Children, in particular, are challenging subjects of photographing. When photographing children, different sound clips can be used compared to photographing adults. Activation of a sound clip according to the embodiments of the invention typically attracts children's attention and calms them down to stay still during photographing, allowing the photographer to concentrate on photographing.

A camera apparatus for taking a picture according to one embodiment of the invention comprises a trigger, which can be activated for taking a picture, and means for activating a certain predefined sound clip after trigger activation, and means for playing the sound clip before taking the picture. According to one embodiment of the invention, the camera apparatus comprises at least sound-reproducing equipment for playing a sound clip and means for activating a sound clip when the camera trigger is activated. The camera may have a sound-reproducing device of its own, such as a loudspeaker. According to another embodiment, the camera is connected to a device comprising sound-reproducing equipment, which allows using the sound-reproducing equipment of this device. The device concerned can be for example a camera phone, i.e. a mobile phone with a camera.

The sound clip according to the embodiments of the invention is typically defined in the settings of the camera apparatus, such as a camera phone. The user can select the sound clip to be used in the embodiments. The sound clip can be available in the device memory or the user can store in the memory a sound clip of his/her own, e.g. one recorded by him/herself, for use in the embodiments of the invention. According to the embodiments of the invention the sound clip feature can also be disabled in the settings such that the camera functions normally without playing the sound clip. The possibility to disable the sound clip feature is important, as there are places and situations for which sound clips are not suitable.

### BRIEF DESCRIPTION OF THE DRAWINGS

The invention is discussed in more detail by making reference to the enclosed figures, which henceforth make a part of the description and in which

FIG. 1 illustrates a method according to one embodiment of the invention, and

FIG. 2 illustrates an apparatus according to one embodiment of the invention, and

FIG. 3 illustrates an apparatus according to one embodiment of the invention.

### DETAILED DESCRIPTION

In the following description and in the figures referred to therein, examples are presented of the various embodiments in which the invention can be carried out. It is understood that embodiments other than those described in this application can also be utilized, and structural and functional modifications can be made without parting from the scope of protection defined in the independent claims of the invention.

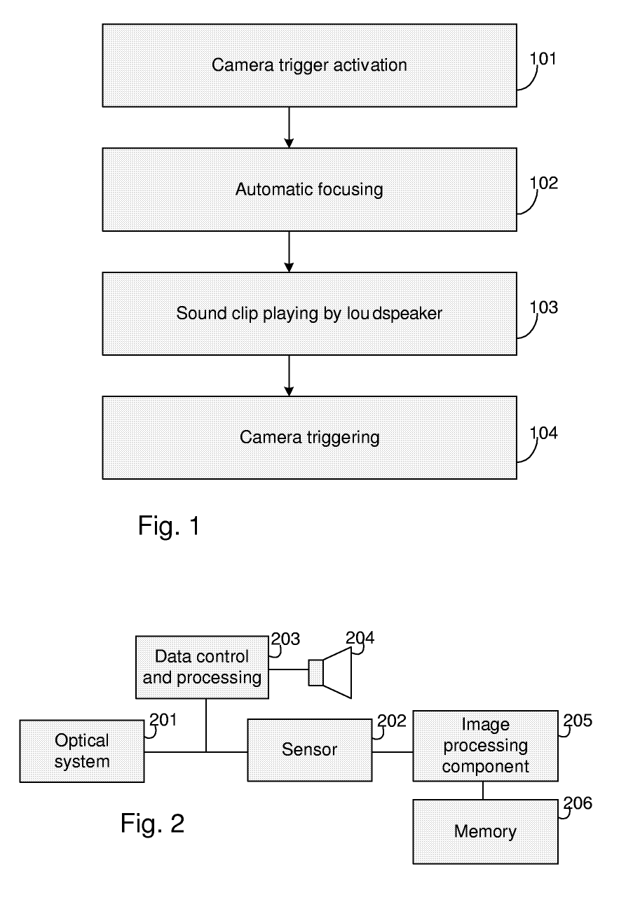

According to the embodiments of the invention, an improved method for taking a picture with a camera device is carried out such that a sound clip is activated, which sound clip is played with the sound-reproducing equipment of the camera device before taking a picture. FIG. 1 shows a method according to one embodiment. In step 101 the camera trigger is activated. Typically the user pushes the trigger. The trigger may be preset or for example remotely-triggerable. When the trigger is pushed, an automatic digital camera typically focuses on the object to be photographed automatically, as is shown in step 102. Automatic focusing of step 102 is performed in some camera devices when the trigger switch is pushed midway. As the result of automatic focusing, the viewfinder becomes focused.

Step 103 involves activation of a sound clip, which is played with the sound-reproducing equipment of the device, such as a loudspeaker. According to one embodiment, the sound clip is activated after automatic focusing of the camera has been performed as the result of trigger activation. According to another embodiment, the sound clip is activated when the trigger is pushed midway. According to a third embodiment of the invention, the sound clip is activated after the camera's viewfinder has been focused as the result of trigger activation. According to a fourth embodiment, the sound clip is activated after a certain predefined time has passed from focusing of the camera's viewfinder.

According to one embodiment of the invention, the sound clip to be activated is predefined in the settings of the camera apparatus. Typically the sound clips are stored in the memory unit of the apparatus, from where they can be selected and retrieved for use in the embodiments of the invention. According to one embodiment of the invention, the sound clip to be activated can be changed and removed in the settings. The user can define the sound clip to be used in each situation in the settings of the camera apparatus. The user can also disable the feature. According to one embodiment the user can also store new sound clips and record them him/herself. According to one embodiment the sound clips are modifiable by the user. In step 103 the sound clip defined in the settings is played with the sound-reproducing equipment. Once the sound clip has been played in step 103, the camera is triggered for taking a picture in step 104.

According to the embodiments of the invention, the sound clip played before taking the picture can contain for example a laugh, which is very contagious, i.e. makes the hearers, too, laugh. The sound clip is typically used to attract the attention of the subjects photographed, in which case the sound clip is so selected that it is likely to make the hearers to be photographed look at the direction of the sound. The sound clip can be, for example, peculiar or strange as regards the situation, such that the hearers' curiosity is roused and they focus their attention to the sound source. In this way the eyes of the subjects photographed can with great likelihood be directed towards the camera. Another typical object is to make the subjects photographed more relaxed and smiling. Then a generally comical, pleasure associated sound clip is selected, which can be, for example, recorded laughter. Another example of a typical positive and international sound association is baby babble. The sound clip can be selected according to the target group; for example, for making children laugh or become alert, a different sound is typically selected than for making adults relax. When selecting the sound clip, besides the target group, also the photographing situation is considered.

FIG. 2 shows a camera apparatus according to one embodiment of the invention. The camera apparatus comprises an optical system 201, which includes a lens system. The light pattern produced by the lens system 201 is stored in a light-sensitive sensor 202. Before indicating the picture in the sensor 202, the data control and processing block 203 is used to calculate the parameters required at the moment of photographing and to control the photographing operation. Typically the camera trigger is located in the data control and processing block 203. The data control and processing block 203 defines and controls automatic focusing and exposure and possibly other imaging parameters. In addition, according to one embodiment of the invention, the control and processing block 203 comprises instructions for playing a certain sound clip with the loudspeaker 203 of the device before taking a picture. The apparatus according to FIG. 2 comprises sound-reproduction equipment 204 for playing a predefined sound clip before taking a picture, that is, before indicating the light pattern created by the lens system 201 in the sensor 202. According to one embodiment, the data control and processing block 203 transfers the sound clip to be performed, which it receives for example from the device memory, to the loudspeaker 204. According to another embodiment, the data control and processing block 203 assigns the execution turn to the controller, which includes instructions for playing a predefined sound clip by means of the parameters provided before taking the picture. The object to be photographed is exposed to the light-sensitive sensor 202 of a digital camera. The sensor 202 has light-sensitive dots for indicating the exposed object. The data detected with the sensor 202 is converted to electronic form. Electronic data is processed with an image processing component 205. Typically the image data is compressed with the image processing component 205. Processed data can be stored in the device memory 206 or transferred, for example, for display with a display unit.

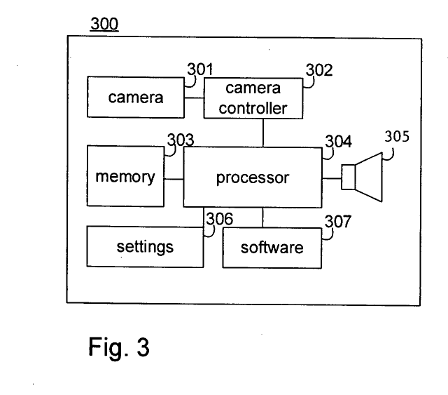

FIG. 3 shows an apparatus 300 according to one embodiment of the invention, comprising a camera 301. A mobile phone, for example, is this type of camera apparatus. In FIG. 3 only the parts most essential for the embodiments of the invention are shown. Typically a camera apparatus also has other parts and blocks than those shown here. The apparatus 300 of FIG. 3 comprises a processor 304, which directs and controls the blocks and functions of the device. A camera controller 302 controls the functions of the camera 301 of the device 300. The camera controller 302 transfers to the processor 304 instructions to play the sound clip according to the embodiments of the invention before taking a picture. The sound clips are typically stored in the memory unit 303 of the camera apparatus 300. According to the embodiments the user can record and store new sound clips in the memory 303. The sound clip to be played before photographing is defined, according to one embodiment, in the settings 306 of the device 300. The processor 304 can typically retrieve the information on the sound clip to be used from the settings 306, based on which information the processor 304 can retrieve this sound clip from the memory 303. After this the processor 304 typically also transfers the sound clip to the sound-reproducing equipment, for example via a sound controller to a loudspeaker 305, for performing the sound clip. The functions according to the embodiments can be defined in the software 307, which is run in the processor 304 before taking a picture with the camera 301. According to one embodiment of the invention the apparatus 300 comprises programmable means for carrying out the method steps according to one embodiment of the invention.

The camera apparatus according to the embodiment of the invention typically comprises a trigger, which can be activated for taking a picture, means for activating a certain predefined sound clip after trigger activation, and sound-reproducing equipment for playing a sound clip before taking a picture. According to one embodiment the camera apparatus is composed of a camera comprising means for carrying out the embodiments of the invention, such as a loudspeaker, as is shown in FIG. 2. According to another embodiment, the camera apparatus is composed of an apparatus, which itself comprises sound-reproducing equipment, and of a camera connected to the apparatus, as shown in FIG. 3. The camera can be removably connected to the apparatus or it can be fixedly integrated in it, already in the production stage, for example.

According to one embodiment, the camera apparatus comprises means for activating a sound clip after the camera's automatic focusing has been performed as the result of trigger activation. A camera apparatus according to one embodiment of the invention comprises means for activating a sound clip, when the trigger is pushed midway. In some camera models automatic focusing is performed when the trigger is pushed midway, which allows a simultaneous performance of automatic focusing and playing of the sound clip according to one embodiment of the invention. A camera apparatus according to one embodiment comprises means for activating a sound clip after the camera's viewfinder has been focused as the result of trigger activation. A camera apparatus according to another embodiment comprises means for activating a sound clip after a certain predefined time has passed from focusing of the camera's viewfinder. The settings for performing the sound clip according to the embodiments of the invention can be located in the camera controller, the data control and processing block, separate software or a similar place, from which they can be taken into use just before taking a picture with the camera. The means for activating a sound clip is typically a processor 304 and associated software 305 executed by the processor.

According to an embodiment of the invention, the sound clip is played before and during taking a picture. The equipment according to the embodiment includes the sound-reproducing equipment for playing a sound clip before and during taking the picture. According to an embodiment the picture is taken after certain predetermined period has passed from the activation of the sound clip, and the sound clip is played to an end during and possibly also after the picture is taken. The activation of the sound clip causes the sound clip to be played through, and the picture can be taken before the clip has been ended. In an embodiment of the invention, the time between activation of the sound clip and taking the picture can be defined in the camera settings.

According to one embodiment of the invention, the sound clip to be activated is definable in the settings of the camera apparatus. Before taking the picture, the sound clip or its data can be retrieved from the settings, from where it can be transferred, by means of the camera controller or the data control and processing block, via the processor or directly to the sound controller, which transfers it further to the sound-reproducing equipment for playing. A camera apparatus according to one embodiment of the invention comprises means for changing or removing the sound clip to be activated in the camera's settings (e.g., the processor and assoicated software). The user can modify the settings and define the sound clip to be used, or specifically completely disable the feature. According to one embodiment it is possible to define in the settings that the feature is completely skipped. According to another embodiment, when the user defines that the function is not carried out, a soundless sound clip is taken, which is played according to the embodiments of the invention. A camera apparatus according to one embodiment comprises means for modifying sound clips (e.g., the processor and assoicated software) and for storing and recording new sound clips. Typically the means according to the embodiments of the invention are programmable, executable means.

What is claimed is:

1. A method for taking a picture with a camera apparatus comprising:
activating a certain predefined sound clip of the camera apparatus when a trigger for taking the picture is activated, and
playing the sound clip with sound-reproducing equipment of the camera apparatus before taking the picture.

2. A method according to claim 1, wherein the sound clip is played with sound-reproducing equipment of a device to which the camera apparatus is connected.

3. A method according to claim 1, wherein the sound clip is activated after automatic focusing of the camera apparatus has been performed as the result of trigger activation.

4. A method according to claim 1, wherein the sound clip is activated when the trigger is pushed midway.

5. A method according to claim 1, wherein the sound clip is activated after a viewfinder of the camera apparatus has been focused as the result of trigger activation.

6. A method according to claim 5, wherein the sound clip is activated after a certain predefined time has passed from focusing of the camera's viewfinder.

7. A method according to claim 1, wherein the sound clip is played before and during taking of the picture.

8. A method according to claim 1, wherein the sound clip to be activated is predefined in settings of the camera apparatus.

9. A method according to claim 1, wherein the sound clip to be activated can be changed and/or removed in settings of the camera apparatus.

10. A method according to claim 1, wherein the sound clip is modifiable by the user of the camera apparatus.

11. (canceled)

12. A camera apparatus for taking a picture comprising:
a trigger, which can be activated for taking a picture,
a processor configured for activating a certain predefined sound clip after trigger activation, and
sound-reproducing equipment, in communication with said processor, for playing a sound clip before taking a picture.

13. A camera apparatus according to claim 12, wherein the camera is connected to a device, which device comprises the sound-reproducing equipment for playing a sound clip.

14. A camera apparatus according to claim 12, wherein said processor is configured for activating a sound clip after automatic focusing of the camera has been performed as the result of trigger activation.

15. A camera apparatus according to claim 12, wherein said processor is configured for activating a sound clip when the trigger is pushed midway.

16. A camera apparatus according to claim 12, wherein said processor is configured for activating a sound clip after a viewfinder of the camera has been focused as the result of trigger activation.

17. A camera apparatus according to claim 16, wherein said processor is configured for activating a sound clip after a certain predefined time has passed from focusing of the camera's viewfinder.

18. A camera apparatus according to claim 12 comprising camera apparatus settings for storing a specification for defining the sound clip to be activated.

19. A camera apparatus according to claim 12, wherein said processor is configured for changing and removing the sound clip to be activated in the settings of the camera.

20. A camera apparatus according to claim 1, wherein said processor is configured for modifying the sound clip.

21. A camera apparatus according to claim 12, wherein said processor is programmable.

22. A camera apparatus according to claim 12, wherein the sound-reproducing equipment is configured for playing a sound clip before and during taking the picture.

23. A camera apparatus for taking a picture comprising:
means for taking a picture,
means for activating a certain predefined sound clip after the means for taking a picture has been activated, and
means for playing a sound clip before taking a picture.

24. A camera apparatus according to claim 23, wherein said means for activating a sound clip is configured for activating a sound clip after automatic focusing of the camera has been performed as the result of the means for taking a picture has been activated.
